(19) United States
(12) Patent Application Publication
(10) Pub. No.: US 2012/0245745 A1
(43) Pub. Date: Sep. 27, 2012

(54) USER INTERFACE FOR A MOBILE COMPUTING DEVICE

(75) Inventors: Roeland Vandevelde, American Canyon, CA (US); Wayne Miller, Los Altos, CA (US)

(73) Assignee: GREENVOLTS, INC., Fremont, CA (US)

(21) Appl. No.: 13/490,084

(22) Filed: Jun. 6, 2012

Related U.S. Application Data
(63) Continuation-in-part of application No. 13/227,695, filed on Sep. 8, 2011.
(60) Provisional application No. 61/424,537, filed on Dec. 17, 2010.
(60) Provisional application No. 61/424,515, filed on Dec. 17, 2010.
(60) Provisional application No. 61/424,518, filed on Dec. 17, 2010.
(60) Provisional application No. 61/424,493, filed on Dec. 17, 2010.

(51) Int. Cl. G06F 1/26; G06F 3/048; G06F 3/041

(52) U.S. Cl. 700/286

(57) ABSTRACT

An energy-management application may be resident on a mobile computing device to access information and control components associated with one or more solar generation sites. A graphic user interface presents multiple pages to both 1) monitor information regarding the solar generation sites and 2) control components within the solar generation sites from the mobile computing device. The application detects as an input on a currently displayed page from the sequence of multiple pages both a rate and a pattern of finger swipe gestures made on the currently displayed page. The application, in response to detection of both the rate and pattern of the finger gestures on the touch screen display, performs at least one of 1) activation of one or more of the data items, one or more of the links, or one or more of the objects, and 2) navigation to another page in the sequence of pages.

### RELATED APPLICATIONS

This application claims the benefit of and is a continuation in part of U.S. Patent Application titled “BROWSER-BASED BACK-END MANAGEMENT SYSTEM FOR A CONCENTRATED PHOTOVOLTAIC (CPV) SYSTEM” filed on Sep. 8, 2011 having application Ser. No. 13/227,695, which application claims the benefit under U.S. Provisional Application 35 USC 119 of and priority to U.S. Provisional Application titled “INTEGRATED ELECTRONICS SYSTEM” filed on Dec. 17, 2010 having application Ser. No. 61/424,537, U.S. Provisional Application titled “TWO AXIS TRACKER AND TRACKER CALIBRATION” filed on Dec. 17, 2010 having application Ser. No. 61/424,515, U.S. Provisional Application titled “PV CELLS AND PADDLES” filed on Dec. 17, 2010 having application Ser. No. 61/424,518, and U.S. Provisional Application titled “ISIS AND WIFI” filed on Dec. 17, 2010 having application Ser. No. 61/424,493.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### FIELD

Embodiments of the present invention generally relate to the field of solar power, and in some embodiments, specifically relate to using an application on a mobile computing device to access information and control operations of a solar site.

### BACKGROUND

A solar site may include many devices. Each of these devices may be able to provide useful information. There has not been an efficient technique to manage this useful information.

### SUMMARY

Various methods and apparatus are described for a client mobile computing system to access information and control components associated with a solar site using the Internet. One or more remote solar-powered generation sites may be managed from an energy-management application resident on a mobile computing device. Bidirectional communications occur between an Internet-based management server system and the energy-management-application. A touch-screen graphic user interface presents multiple pages to both 1) monitor information, including site conditions and electrical energy production, regarding one or more remote solar-powered generation sites and 2) control components, including positioning of solar arrays, within the one or more remote solar-powered generation sites from the mobile computing client device having a touch screen display. The graphic user interface displays on the touch screen a sequence of the multiple pages, where each page contains any of a list of data items, links, and objects, across various hierarchical levels of the one or more remote solar-powered generation sites on the touch screen display. The sequence of the multiple pages is organized into the hierarchical levels going from an overview of the one or more remote solar-powered generation sites to lower levels such as individual components making up an individual remote solar-powered generation site. The application detects as an input on a currently displayed page from the sequence of multiple pages both a rate and a pattern of finger swipe gestures made on the currently displayed page. The application, in response to detection of both the rate and pattern of the finger gestures on the touch screen, performs at least one of 1) activation of one or more of the data items, one or more of the links, or one or more of the objects, and 2) navigation to another page in the sequence of pages. A user of the mobile computing device is able to interact with the energy-management-application to control and monitor the one or more solar power generation sites by navigating through the sequence of multiple pages, interacting with the data items, the links, and the objects contained on the pages.

### BRIEF DESCRIPTION OF THE DRAWINGS

The multiple drawings refer to the embodiments of the invention.

FIGS. 1a and 1b illustrate embodiments of example Portfolio level dashboard pages presented by a graphic user interface of an energy-management-application onto a touch screen display of a mobile computing client device.

FIG. 2 illustrates a flow diagram of an embodiment of an example sequence of pages and example types of pages presented by an embodiment of the energy-management-application.

FIGS. 3A and FIG. 3B illustrate an example overall navigation between Dashboard pages within hierarchal levels of the solar generation sites presented by the graphic user interface of the energy-management-application.

FIG. 4 illustrates an embodiment of example login page presented by the graphic user interface of the energy-management-application onto the touch screen display of the mobile computing device.

FIG. 5 illustrates an embodiment of example Power verses DNI dashboard page at a site level in the hierarchical level presented by the graphic user interface of the energy-management-application onto the touch screen display of the mobile computing device.

FIGS. 6A and 6B illustrate embodiments of example tile objects on a displayed tracker tile dashboard page at a Site level in the hierarchical level presented by the graphic user interface of the energy-management-application onto the touch screen display of the mobile computing device.

FIG. 7 illustrates an embodiment of example camera view dashboard page of a section of solar arrays at a section level in the hierarchical level presented by the graphic user interface of the energy-management-application onto the touch screen display of the mobile computing device.

FIG. 8 illustrates an embodiment of example individual inverter dashboard page at an array/component level in the hierarchical level presented by the graphic user interface of the energy-management-application onto the touch screen display of the mobile computing device.

FIG. 9 illustrates an embodiment of example total energy dashboard page at a string of photovoltaic cells hierarchy level presented by a graphic user interface of an energy-management-application.

FIG. 10A illustrates an embodiment of example Control page at an array level in the hierarchical level presented by the graphic user interface of the energy-management-application onto the touch screen display of the mobile computing device.

FIG. 10B illustrates an embodiment of example tracker dashboard page at an array level in the hierarchical level presented by the graphic user interface.

FIG. 11 illustrates an embodiment of example Alarms and Alerts page presented by a graphic user interface of an energy-management-application.

FIG. 12 illustrates an embodiment of multiple mobile computing client devices, each with its own resident energy-management-application that cooperates over the Internet with a management server system and different solar power generation sites in a portfolio.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific finger gestures, named components, connections, types of circuits, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references (e.g., a first array, a second array, etc.) may be made. However, the specific numeric reference should not be interpreted as a literal sequential order but rather interpreted that the first array is different than the second array. Thus, the specific details set forth are merely exemplary. The specific details may vary from and still be contemplated to be within the spirit and scope of the present invention.

In general, various methods and apparatus associated with accessing information from a solar site by using a browser in a client computing system and connecting to a backend management system using the Internet are discussed. In an embodiment, an energy-management-application is configured to operate on a mobile computing device. The energy management application connects to and facilitates bidirectional communications with the Internet-based management server system. The energy-management-application presents a touch-screen graphic user interface that has multiple pages. The GUI allows both 1) monitor information, including site conditions and electrical energy production, regarding one or more remote solar-powered generation sites and 2) control of components, including positioning of solar arrays, within the one or more remote solar-powered generation sites from the mobile computing device. The mobile computing device has a touch screen display. The graphic user interface is configured to display on the touch screen a sequence of the multiple pages. Each page contains any of the following a list of data items, links, and objects, across various hierarchical levels of the one or more remote solar-powered generation sites on the touch screen display. The sequence of the multiple pages are organized into the hierarchical levels going from an overview of the one or more remote solar-powered generation sites to lower levels including individual components making up an individual remote solar-powered generation site. The energy-management-application is configured to detect as an input on a currently displayed page from the sequence of multiple pages both a rate and a pattern of finger swipe gestures made on the currently displayed page displayed on the touch screen display. The application, in response to detection of both the rate and pattern of the finger gestures on the touch screen, performs at least one of 1) activate one or more of the data items, one or more of the links, or one or more of the objects, and 2) navigate to another page in the sequence of pages. A user of the mobile computing device is able to interact with the energy-management-application to control and monitor the one or more solar power generation sites by navigating through the sequence of multiple pages, interacting with the data items, the links, and the objects contained on the pages.

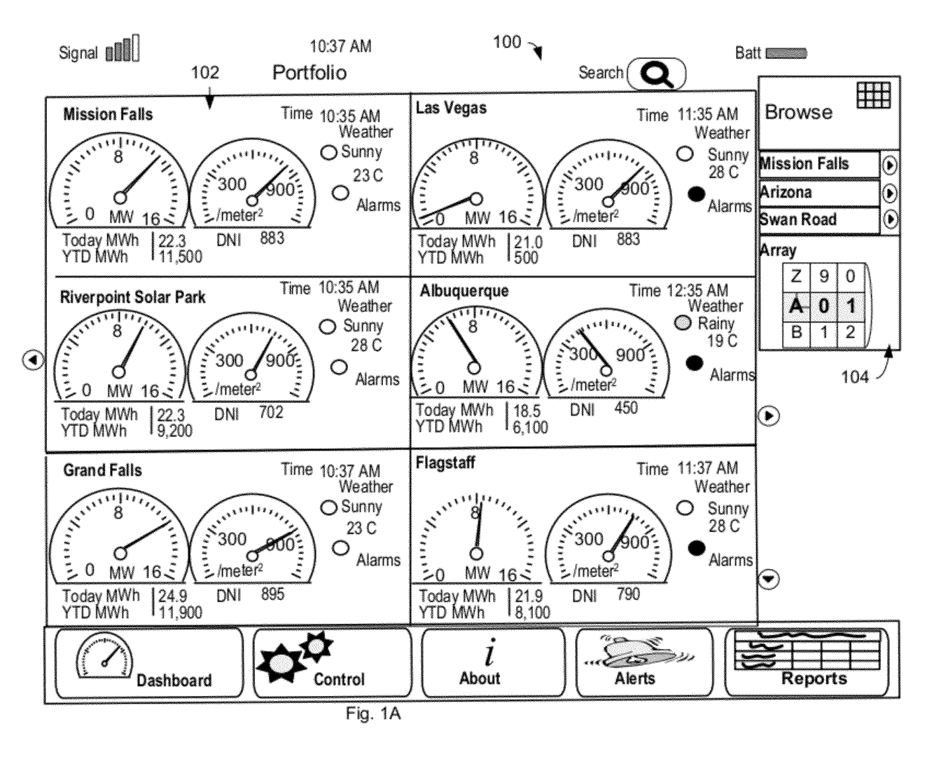

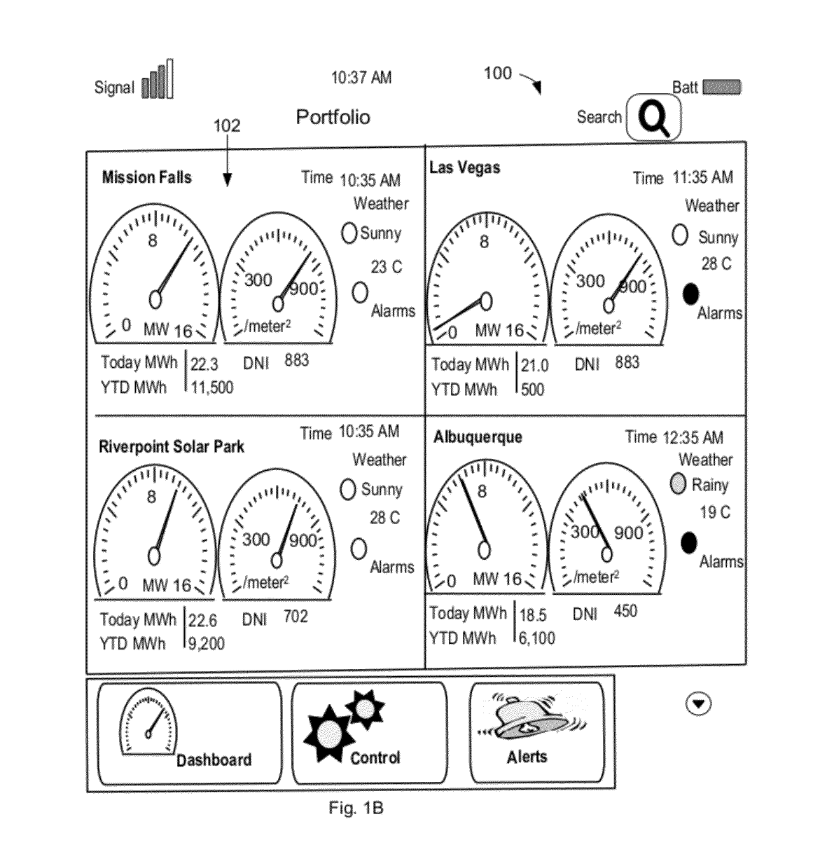

FIGS. 1a and 1b illustrate embodiments of example Portfolio level dashboard pages presented by a graphic user interface of an energy-management-application onto a touch screen display of a mobile computing client device.

The energy-management-application presents a touch-screen graphic user interface that has multiple pages. The GUI allows both 1) monitor information, including site conditions and electrical energy production, regarding one or more remote solar-powered generation sites and 2) control of components, including positioning of solar arrays, within the one or more remote solar-powered generation sites from the mobile computing device. The mobile computing device has a touch screen display. The graphic user interface is configured to display on the touch screen a sequence of the multiple pages. Each page contains any of the following a list of data items, links, and objects, across various hierarchical levels of the one or more remote solar-powered generation sites on the touch screen display. The sequence of the multiple pages are organized into the hierarchical levels going from an overview of the one or more remote solar-powered generation sites to lower levels including individual components making up an individual remote solar-powered generation site.

The energy-management-application may be configured to initially navigate a user to a portfolio dashboard page 100 in the sequence of pages. The portfolio dashboard page 100 displays an overview of the one or more solar power generation sites. A login page may or may not be presented in the sequence of pages. The portfolio dashboard page 100 in the hierarchal level presents a tile object for each of the solar generation sites that the user is allowed to see. For example, a first site-tile object for the Mission Falls solar-powered generation site 102. The energy-management-application is configured to detect a finger scrolling gesture to go up and down on the list of tile objects in order to bring a certain solar generation site-tile into view as well as potentially laterally side to side to bring solar generation site-tile objects on the portfolio dashboard page 100 into view.

The energy-management-application is configured to detect as an input on a currently displayed page from the sequence of multiple pages both a rate and a pattern of finger swipe gestures made on the currently displayed page displayed on the touch screen display. In response to detection of both the rate and pattern of the finger gestures on the touch screen, the energy-management-application activates any of the data items, the links, the objects, as well as navigates to another page in the sequence of pages, or sends a finger gesture-based command to the Internet-based management server system. A user of the mobile computing device interacts with the energy-management-application to control and monitor the one or more solar power generation sites by navigating through the sequence of multiple pages, interacting with the data items, the links, and the objects contained on the pages, and using finger gesture-based commands on the pages.

Each solar generation site-tile object, such as the Mission Falls site-tile object 102, may include two or more dials indicating 1) current electrical power generation being produced at that solar generation site and 2) an amount of Sun present, such as direct normal irradiation (DNI) information, at that solar generation site. The displayed combination of power produced and Sun present allows for an easy detection of a properly functioning solar generation site from a solar generation site that may have a problem. The user can select individual solar sites to navigate to by finger ‘clicking’ with two or more finger presses in a rapid succession on that individual solar generation site-tile object on the portfolio page 100. Thus, the user can make two finger taps within a fixed period of time, such as less than a one second duration, on the touch screen at the geographic location of that solar generation site-tile object on the page to navigate to that particular solar generation site's dashboard page in the hierarchical level. That solar generation site's dashboard page then displays array-tile objects for all of the solar arrays at that solar generation site and power being produced out of each individual solar array at that solar generation site. The combination of displayed information of power being produced and DNI for each solar array allows the user to rapidly assess which individual solar arrays at that solar generation site are causing the solar generation site to poorly perform. Thus, the energy-management-application is configured to drill down in the hierarchy of levels to a specific solar generation site in the portfolio through one additional double click with a finger on a solar generation site-tile object of a poorly performing site shown on the portfolio dashboard page 100, which causes a drill down to a site dashboard page in the hierarchical level to display array-tile objects of all of the solar arrays at that solar generation site and power being produced out of each individual solar array at that solar generation site. A user of the downloadable mobile computing device can easily see which particular solar array(s) is performing badly based on the current amount of Sun present at that solar generation site and electrical power produced. The downloadable mobile application configures the sequence of pages presented to allow a user to visually see and detect, with merely two finger double clicks, what particular components are causing problems in the portfolio.

Thus, users of mobile device interact with the downloadable application to control and monitor the one or more solar power generation sites by navigating through the pages of the Dashboard, Service, Alerts, About, Reports across various hierarchical levels of the one or more remote solar-powered generation sites. The hierarchical levels may include example Portfolio, Section, Site, Array, and String levels.

The Portfolio hierarchical level includes all of the one or more remote solar-powered generation sites this user should have access to. As discussed, the Portfolio dashboard page 100 has multiple site-tile objects. Each site-tile object contains at least the following a Site location name; a dial to indicate current power production of the site, with daily and year-to-date energy production; the dial is scaled with numeric parameters from that site, such as 0-16, and a red/green circular LED to indicate if there are alarms on the site. The example two dials in the tile object represent the amount of electric power being produced from the strings of Concentrated PhotoVoltaic cells in the solar arrays at that site and a direct normal irradiation (DNI) information for at that site. The markers in the Power dial are based on the number of active solar arrays in the entity. For example, each solar array can produce, for example, a maximum of 16 kW, and so the maximum value of the dial is defined as the number of solar arrays times 16 kW. The Mission Falls site, for example, may have one thousand solar arrays. Thus, the power dial indicates 0-16 MW. The DNI dial has a constant maximum value of 1200 per meter². The Power and DNI gauges can be dimmed if there has been no corresponding information for the past two or more snapshots cycles.

Independent of a level of hierarchy, the energy-management-application provides and displays on pages many different kinds of tile objects, which consists of visual objects including graphics design files. Each of these tile objects, such as the Mission Falls site-tile object 102, display parameter data that uses at least a two-tier image system. The two-tier image system in the construction of the tile object includes 1) a composite of one or more fixed images and then 2) a data overlay display onto the fixed images. The data overlay display updates and illustrates data content periodically sent from the management server system. For example, the dial portion with its incremental markings and gauge appearance is part of the fixed image and the needle is the data display overlay. Likewise, the fixed part of a graph with its incremental markings and X axis and Y axis would be presented in the fixed images and the plotted graph line would be the data overlay display. The composite of one or more fixed images contain a majority of the detailed visual features and are set as a high quality fixed image. The data overlay graphically illustrates of a current data from the backend server that overlays the composite of one or more fixed images.

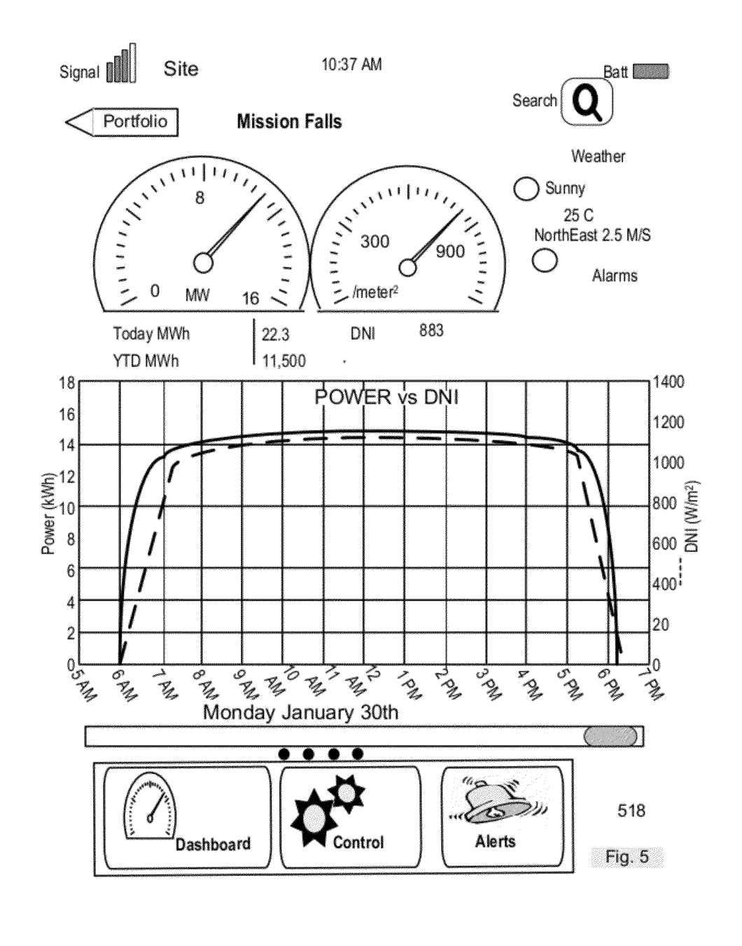

The energy-management-application presents a top portion of a displayed page conveying a title of the location the browser has currently navigated to in the hierarchical levels and generally a visual indication of how to navigate through the hierarchy of levels. In an embodiment, the energy-management-application may present a visual indication of a pop up window 104a with a table of user selectable options of the levels of hierarchy and pages this user is allowed to navigate to. In another embodiment, the energy-management-application may present a visual indication of a Back button that indicates the next higher level in the hierarchy such as Portfolio level. (See FIG. 5 for example). The energy-management-application allows the navigation up the hierarchical levels by the user depressing the Back button that indicates the next higher level such as Portfolio level, Site level, Section level, Array level. Hierarchical levels also can be navigated through by drilling down/clicking on the tile-objects.

Referring to the pop up window 104, which is used to navigate through the levels of hierarchy, the window 104 provides a list of site entities for the currently logged in user has access to. The items displayed in the drop down fields in the window are filtered based on the selection at the parent level in the hierarchy. The dials on this pop up window 104 depend on the selected item: if the site, such as Mission Falls, > link arrow is pressed, the dial area changes to reflect the choice of sites; same for section and portfolio. If the array > link arrow is selected, the dials show the letters, such as A, (only the available letters, depending on the array table) and one or two digits of numbers such as 01, can be selected for the available arrays.

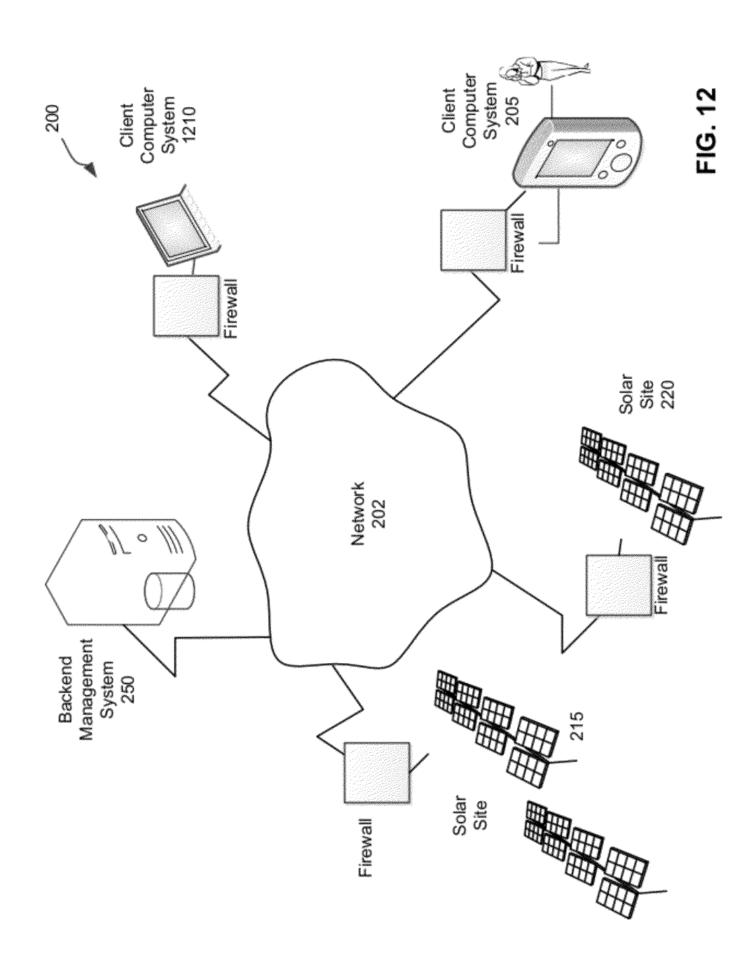

FIG. 12 illustrates an embodiment of multiple mobile computing client devices, each with its own resident energy-management-application that cooperates over the Internet with a management server system and different solar power generation sites in a portfolio. The energy-management-application may be downloaded over the Internet from a server onto a mobile computing client device, 205 or 1210. The energy-management-application is configured to self-install and to be executed residently on the mobile computing client device 205, 1210. The energy management application is configured to connect to and facilitate bidirectional communications with the Internet-based management server system, 250. The management server system then communicates with the different solar power generation sites 215, 220.

The management server system 250 may be coupled to a network 202, which may be the Internet, and configured to enable users to control and manage solar sites from anywhere over the network 202. In the current example, solar sites 215, 220 may also be coupled to the network 202. There may be a firewall at each of the respective solar sites 215, 220.

The downloadable Internet-based energy management software also connects to the Internet-based backend management system using the wide area network 202. The downloadable Internet-based energy management software information supplies user's information including authenticating information to the management server system 250, which then performs a security look up. As discussed, the energy management software presents a sequence of pages viewable with a browser of a user's client mobile device 205, 1210 to enable the user 1) to navigate the hierarchical levels, also 2) view information for various components, 3) send one or more commands to perform an action for various components within each solar generation site, and 4) any combination of these for the various components associated with the CPV arrays. The multiple pages are viewable with the browser and are then presented on a display of the mobile client computing device 205, 1210 based on the management server system 250 having authenticated the user as being allowed to view the information related to the CPV array. Overall, the Internet-based management server system 250 cooperates with multiple instances of the downloadable Internet-based energy management software application. This system allows for real-time monitoring of solar generation site conditions and energy production, fault isolation and diagnostics, operation and maintenance logs, remote access and control of the entire system and hundreds of alerts and alarms.

Referring to FIGS. 1A and 1B, the user can also use a menu bar to navigate between pages including Dashboards, an Alerts page that has list to view Alerts and Alarms, and a Control page to control solar array positions on the solar tracker mechanisms, by selecting the appropriate icon on the bottom menu bar.

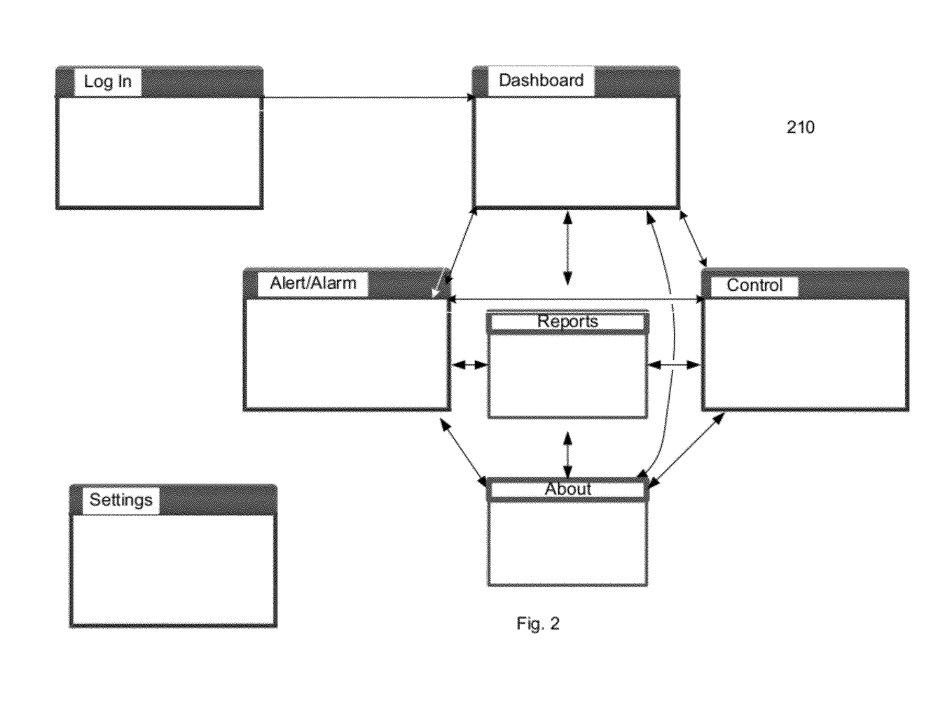

FIG. 2 illustrates a flow diagram of an embodiment of an example sequence of pages and example types of pages presented by an embodiment of the energy-management-application. The overall flow of pages includes initially a log-in page for a user to log on to the system from the energy management application 210. The energy management application 210 then navigates to the dashboard pages, landing by default on the portfolio dashboard page. The user can then view dashboard pages for each solar generation site in the entire portfolio. The energy-management-application 210 presents a visual indication, including menus, pop-up windows, back level buttons, and/or navigation geometric shapes, to allow navigation between the pages of the Dashboard pages, Control pages, Alert pages, About pages, and Report pages across the various hierarchical levels of the one or more remote solar-powered generation sites. The energy-management-application 210 also can present a settings page.

Thus, users of mobile device interact with the downloadable application 210 to control and monitor the one or more solar power generation sites by navigating through the pages of the Dashboard, Control, Alerts, About,

Reports, as well as across various hierarchical levels of the one or more remote solar-powered generation sites.

The graphic user interface of the energy-management-application 210 presents one or more dashboard pages that display at least the site conditions and electrical energy production. The graphic user interface of the energy-management-application 210 also presents and allows navigation to at least Alert pages to display any alert and alarm conditions in the one or more solar power generation sites, Control pages to control solar array positions in the one or more solar power generation sites, and the other types of pages.

Some pages can be navigated to only when on certain levels of the hierarchy. For example, the Control page may be only available on the ‘array hierarchy level’. On all other hierarchy levels (portfolio, site, section, string), the control button is disabled and navigation to the control page is not possible. The Alerts page may be not available on the ‘portfolio hierarchy level’ and ‘string hierarchy level’, but is available on all other hierarchy levels.

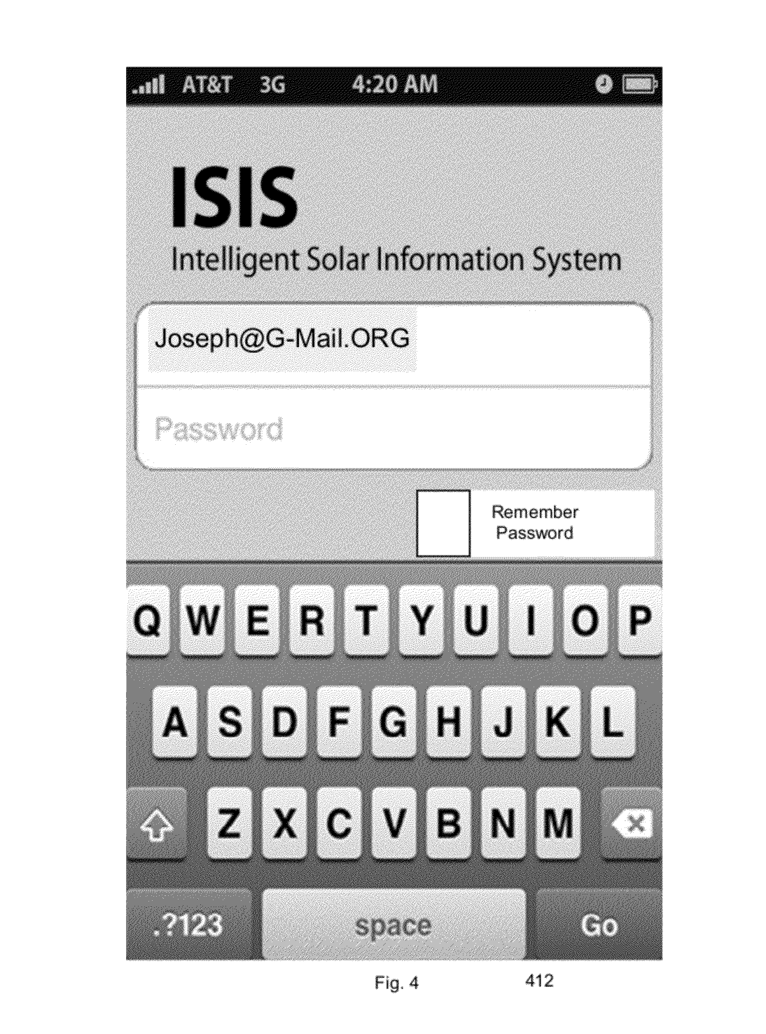

The energy-management-application 210 has a Settings plug-in routine that is scripted to work with and integrate with the settings' routine of the mobile computing device. The Settings plug-in routine acts as an interface so that the settings page of the mobile application 210 is accessible from at least one of 1) a standard ‘settings’ folder of the mobile computing device, and 2) a settings link from the sequence of pages presented by the mobile downloadable application 210. A field and an algorithm of the settings page are configured to sign in the user of this mobile device into the Internet-based management server system automatically when the energy-management application 210 is resident and run on the mobile computing device and when automatically signed in the initial log-in page will skipped in the sequence of presented pages. When automatic sign-in field is selected on the settings page or login page, the downloadable mobile application 210 will store locally and remember the username and password, and the initial log on screen will skipped in the sequence of presented pages and never again be shown to the user. (For example see the field in FIG. 4)

The setting page also has a field to allow a command to be generated when on a dashboard page. The command ‘Shake to Reload’ will be used in all the ‘energy’, ‘power vs. DNI’, ‘tiles’, ‘tracker’ and ‘inverter’ dashboard pages. When activated, the data will be reloaded when the mobile computing device is shaken. For example, Shake to Reload when activated, a dashboard page with a graph will reload with new data when the mobile computing device is shaken. Similarly, the still images from the camera can be updated more frequently than the standard periodic rate by shaking the mobile computing device to reload that page.

The energy-management application 210 may also be configured to respond to voice commands as well. Thus, the energy-management may be configured to respond to finger gesture command, voice commands, and shaking commands.

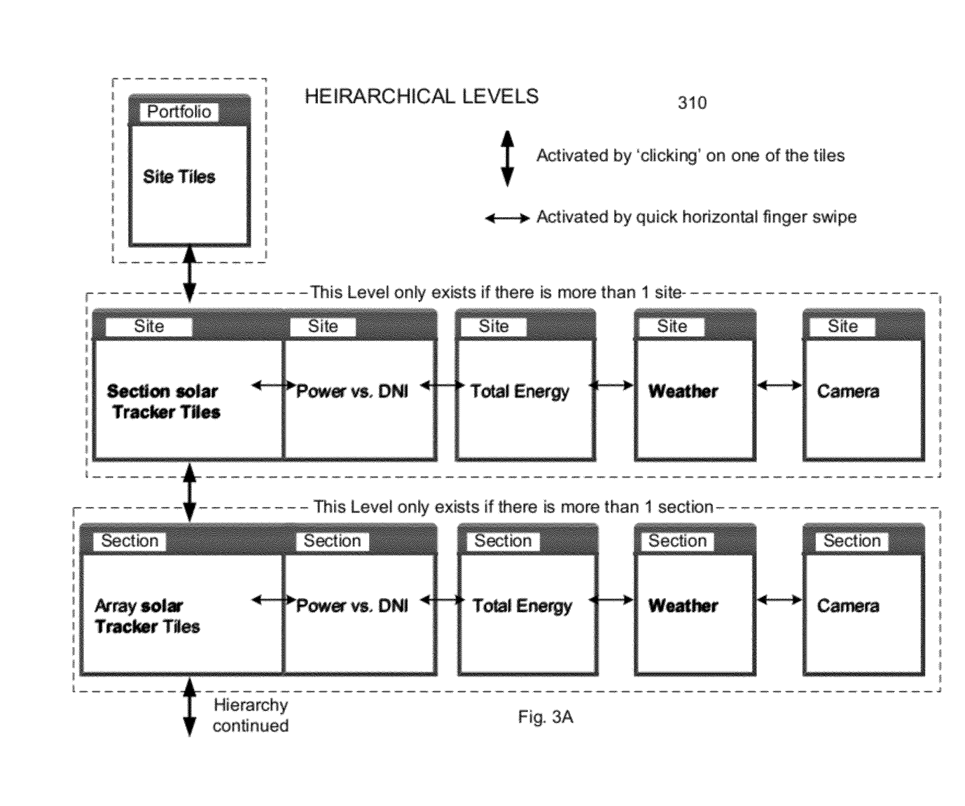

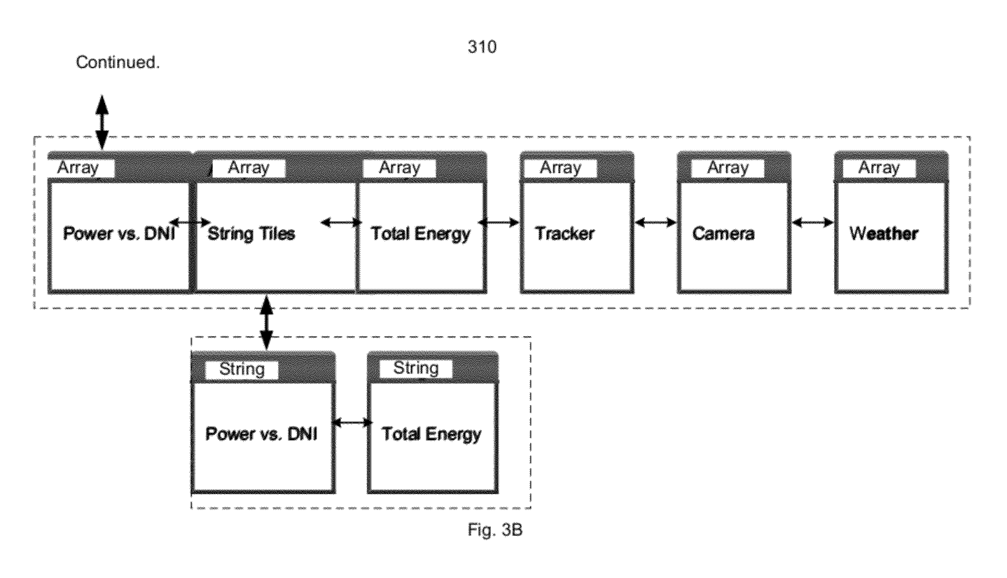

FIGS. 3A and FIG. 3B illustrate an example overall navigation between Dashboard pages within hierarchal levels of the solar generation sites presented by the graphic user interface of the energy-management-application.

The example hierarchical levels include levels such as a Portfolio level; a Section level; a Site level; an individual solar Array level; and a string of solar cells or other individual components associated with a particular solar array level. The Portfolio hierarchical level includes all of the one or more remote solar-powered generation sites this user should have access to. The Portfolio level could additionally list all of the companies for which the currently logged in user has access to. Likewise, the Section hierarchical level includes all of the one or more remote solar-powered generation sites in a specific section or region that this user should have access to. The Section hierarchical level may display all solar arrays in the selected section and list all active solar arrays for that section in a given solar site. The Site hierarchical level is specific to displaying a set of two or more concentrated photovoltaic (CPV) solar arrays and other data specific to one of the solar-powered generation sites. The Array hierarchical level may display individual solar arrays in a given section of a solar site and displays the combined power from two or more strings of solar cells for a selected array. The String hierarchical level may display both East and West active strings for the selected array or other individual components for a given solar array.

A User's access to the sites in the management server system is based on the relation mapped between an assigned User Access Level/Role & that specific solar generation site. The access level controls the operations users can perform in a particular site. The User's ID can be given access to a site if the company to which the user belongs to is related to the site and has been assigned a role.

The graphic user interface of the energy-management-application 310 is configured to guide a web browser of the mobile computing device through the sequence of pages, organized as the hierarchical levels of the one or more solar power generation sites, that can be drilled-down in, drilled-up in, and navigated laterally within while in a given hierarchical level. Each different hierarchical level has different level of granularity of the solar power system and the hierarchy follows the ordering from the high level overview of the one or more solar power generation sites, to a lower level of individual solar power generation sites, to an even a lower level of individual components/arrays making up a particular individual solar power generation site, and then onto a lowest level of individual components/strings of photovoltaic cells making up a single solar array. Note usually tens, hundreds, or even thousands of solar arrays making up an individual solar power generation site.

The energy-management-application 310 is configured to use a combination of links, such as pop up windows, Back level icons, or similar links, as well as finger gestures, such as finger swipes or finger double clicking, to navigate through the different levels of the hierarchy. The finger action allows both drilling down hierarchal levels and lateral navigation within a given hierarchal level in order to view and control different parameters and other information relevant to that level of hierarchy where the user has currently navigated to.

In an embodiment, the hierarchical levels can be drilled-down in from Portfolio to Site to Section to Array to strings or individual components as well as backed up in reverse order. Going ‘up’ a level (from string to array, from array to section, from section to site, from site to portfolio) can be done on every screen, by using the back button on the upper-left corner. (See FIG. 5 for example) Going ‘down’ a level (from portfolio to site/section/array, from site to section/array, from section to array, from array to string) can be done 1) in the pop-up window, where each of the lower-level objects are visualized with a dial, and the user can scroll the dial in view, and ‘click’ on the dial, as well as 2) double finger clicking on a given tile object on the page. Thus, a user can drill up levels 1) by depressing a level Back icon in one instance of the application, and 2) by scrolling and selecting on a navigation pop up window in another instance of the application. Many other visual indications may be used to go up and down in the hierarchical levels. Also, when there is only one site in the portfolio, the navigation will skip the site level, and navigate straight from the portfolio to the section level, and back. Likewise, when there is only one section in the site, the navigation will skip the section level, and navigate straight from the site to the array level, and back.

The dashboard pages will allow navigation between other pages on the same level of hierarchy, and the dashboard pages will also allow navigation between different hierarchical levels of the one or more remote solar-powered generation sites. The downloadable mobile application 310 can navigate laterally for the different types of pages and laterally between the two or more Dashboard pages contained in a given level within the levels of hierarchy. Each dashboard page contains a ‘snapshot’ of relevant information about a specific function or parameter that the user could be interested in. For example, the two or more Dashboard pages within a given level may contain snapshot of information regarding the solar arrays contained at that site/section/component, including Power verses DNI from that site/section/component, Total Energy from that site/section/component, Weather from that site/section/component, Camera views of that site/section/component; and other similarly themed pages. The snapshot will contain useful information about the entity chosen and at the same time displays merely what is vital for user to see because of the limited amount of screen space on most mobile computing devices. Each dashboard presented in the graphic user interface can present data items such as numeric parameters displayed below graphs and dials, and objects indicated by filenames, files represented by icons, and files represented by thumbnails. The dashboard pages present current status information of each Entity level (Site, Section, Array, and String) and generally some history such as daily, monthly, yearly data as well. The current information automatically refreshes at a periodic rate as well as based on finger based commands, and shaking of the mobile computing device.

The sequence of pages presented by the energy management application 310 includes at least Dashboard pages, Alert pages, and Control pages, as well as potentially About pages, and Report pages across various hierarchical levels of the one or more remote solar-powered generation sites that include Portfolio/Section/Site/Array/and String levels.

FIG. 4 illustrates an embodiment of example login page presented by the graphic user interface of the energy-management-application onto the touch screen display of the mobile computing device.

The downloadable mobile application collects any credentials of the user including a User ID, password, and the potentially mobile computing device's ID information, and then securely passes these credentials for authentication by the management server system to log in and access the system. The energy-management-application stores the credentials locally in a memory of the mobile device. The management server system checks the credentials of the user, including User ID, and password, against regularly updated authorization list maintained at server in the management server system as well as permissions associated with that User ID and checks whether the user ID has permission to view certain pages and activate certain command icons.

The energy-management-application is also configured to have an option field, such as Remember Password checkbox on the login page 412 or similar box in the Settings page, for remembering the credentials of the user, which then causes the sequences of pages presented to skip displaying the log-on page 412. A Settings' plug-in routine can snoop the field on the login page 412 and/or in the setting page to automatically supply the user credentials when the energy-management application is resident and run on the mobile computing device in order to skip the login page 412 in the sequence of presented pages.

In an embodiment, the username edit control will show ‘username’ in greyed-out color to indicate that the user should enter the username. Once the user enters a text, the ‘username’ default text disappears and the actually typed text appears. The password edit control shows ‘password’ in greyed-out color to indicate that the user should enter the password. Once the user enters the text of the password, the ‘password’ default text disappears and * characters appear as the user types.

FIG. 5 illustrates an embodiment of example Power verses DNI dashboard page at a site level in the hierarchical level presented by the graphic user interface of the energy-management-application onto the touch screen display of the mobile computing device.

The graphic user interface essentially divides the touch screen display into two or more portions and/or windows for the displayed page, such as a top portion, a middle portion and a bottom portion. Note, some portions of the displayed page remain the same throughout the navigation of the sequence of pages while in other portions the inner content changes based on what particular page the user has navigated to and what types of information this user has access rights to view. The example Power verses DNI dashboard page 518 shows the top middle and bottom portions.

The energy-management-application is configured to present a top portion of a displayed page conveying a title of the location the browser has currently navigated to in the hierarchical levels, such as site, and a visual indication of how to navigate through the hierarchy of levels, such as the pop up window or a back level icon. The top portion typically contains the visual indication of how to navigate through the levels of hierarchy, the time and/or date, a search function, Wireless signal strength for the mobile computing device, and some variable objects and information. The middle portion typically conveys data including images themed for that particular page. The bottom section typically has a menu to call up various types of pages.

The menu bar in the bottom portion of the displayed page allows a user to navigate between at least the different kinds of pages, i.e. dashboard pages, alarm list pages, and control pages, etc., by selecting the corresponding icon on the menu bar. The various navigation bars and menus can be set to auto hide or made to appear by clicking on icons such as arrows in the window. Correspondingly, the navigation bar in form of the pop-up window and can be caused to be shown by clicking the Browse/search button.

The graphic user interface of the energy-management-application is configured to detect two or more of the following 1) a finger touch on a specific geographic location on the displayed page on the touch screen display, 2) the finger touch rate on the touch screen display at that geographic location on the displayed page within set amount of time; 3) an activation of the icon at that geographic location on the displayed page by the finger touch; and 4) the finger touch pattern on the touch screen display. The finger touch pattern includes a pinching gesture with two fingers while contacting the touch screen to magnify that portion of the displayed page on the display screen, a horizontal finger swipe across the touch screen to move the displayed page in the direction of the finger swipe or navigate laterally to another page within that level of the hierarchy, a multiple finger tap at approximately the same coordinates on the touch screen to drill down a level in the hierarchy, or activate an icon, object, link, data item or other item, a vertical finger swipe to cause scrolling normally along an edge of the display screen, and other similar finger gestures.

The Power vs. DNI graph in the middle portion of the displayed page shows a visual representation of the DNI and Power Output of the currently selected hierarchical level. In this case, it is the DNI and Power Output for the solar generation site but could also be at a section, array or even string hierarchical level. The values in Power scale are adjusted based on the particular selection of site and array(s). A string of solar cells can produce a maximum of 8 kilowatts (kW) at any point of time, so a solar array with two strings of solar cells can produce 16 kW maximum. The scale for the section & site is adjusted based on the number of active arrays time 16. The DNI scale on the right axis is fixed 0-1200 for all the Power vs. DNI views. The default selection for the Power vs. DNI is the current day unless the date range selection is modified in the application. A pinching gesture with two fingers while contacting the touch screen will magnify a portion of the graph. Also, fingers swipes left or right within the graph area will scroll to a new time range displayed on the graph. The navigation geometric shapes, such as the four dark circles, indicate that other pages at the same level in the hierarchy exist, and finger swipes outside of the graph area cause navigation to the other pages at the same level in the hierarchy.

The energy-management application contains at least two levels of menus. The bottom menu toolbar contains the page category icons, which the user can navigate by clicking on the buttons. This main menu toolbar in the bottom portion is visible in all pages. The main menu toolbar contains page category icons including a Control/Move icon; Alerts/Alarm icon; a Dashboard icon; and optionally an About icon; and a Reports icon located on a bottom portion of the displayed page. A detailed sub menu structure is presented by the graphic user interface for each main menu page category. Thus, when a main menu page category icon activated, such as a Control page, then the graphic user interface brings up a sub menu associated with that main menu page category. The submenu functions offered varies depending on the page category icon in main menu chosen.

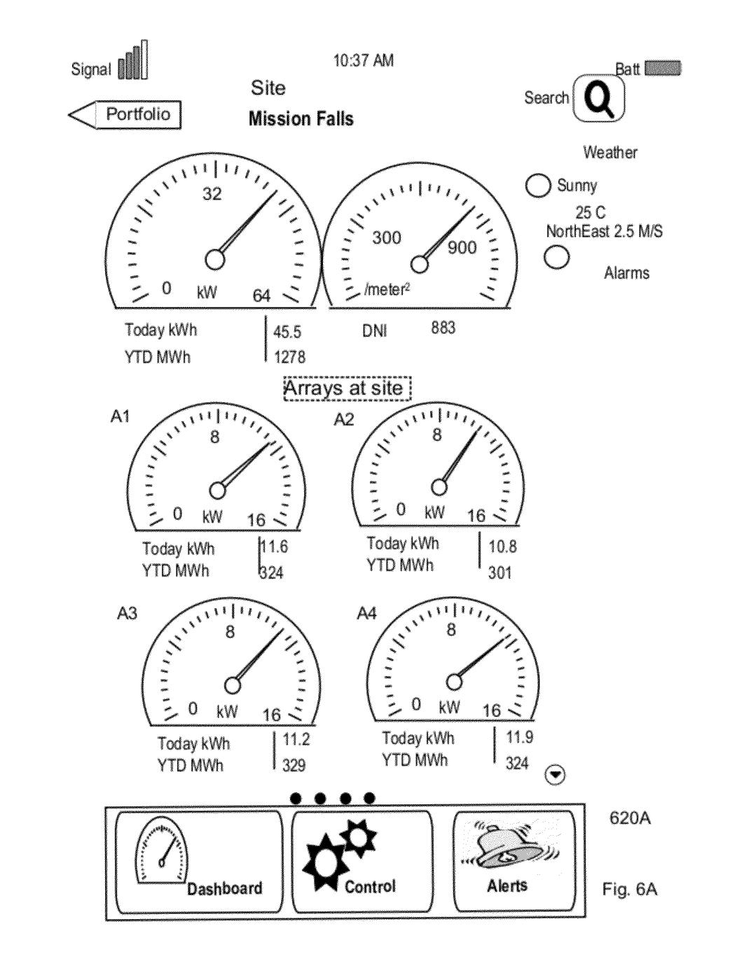

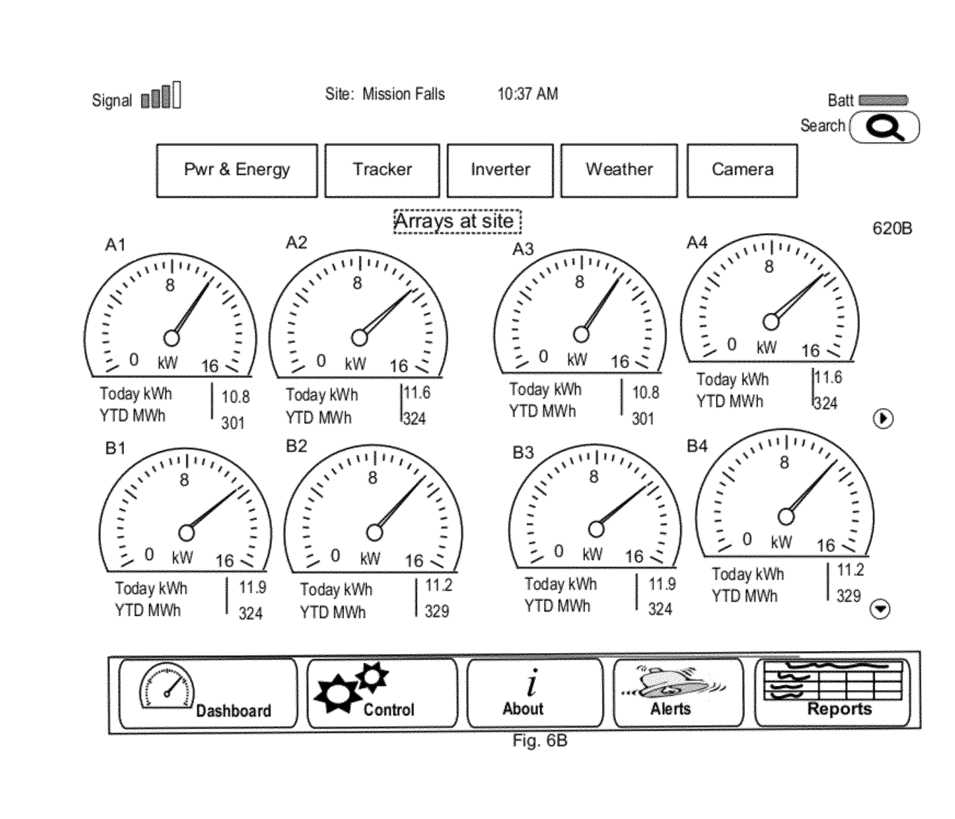

FIGS. 6A and 6B illustrate embodiments of example tile objects on a displayed tracker tile dashboard page at a Site level in the hierarchical level presented by the graphic user interface of the energy-management-application onto the touch screen display of the mobile computing device. FIG. 6A illustrates an embodiment of an example tracker tile dashboard page 620A at a Site level. FIG. 6B illustrates another embodiment of an example tracker tile dashboard page 620B at a Site level.

All of the individual solar arrays at a given solar site are displayed as array-tile objects on this tracker tile dashboard page 620A, 620B. Array tiles provide all the arrays available under a Site or Section based on the navigation selected. The Array tiles are available at both the Site & Section levels. Each solar array is represented by the dial and the dials are ordered in alphabetical order by their display names (A9 comes before A10). For each solar array at the site, the current snapshot information may include the site name, electrical Power production (left dial), Total kWh (since commissioned), YTD kWh, DNI (text & dial), Alerts (Pending Alerts—Open if the red/green led circular button is clicked, Weather conditions (Wind, cloudy, sunny, rainy, current temperature, and time at the entity is displayed. In an example dashboard page 620A, the aggregate power for the site is shown in the top portion of the page as well as the individual power for each of the solar arrays is displayed in the middle portion of the page. Hovering over the Alarm LED allows the user to see how many pending alerts are available for the site.

In an embodiment, the user can finger scroll the list up and down to bring a certain solar array-tile into view on the page 620A. The user can select one of the solar arrays by ‘clicking’ anywhere inside the tile. Solar array-tile objects can be automatically scaled to fit on the page without scrolling. The User is then allowed to zoom in or out with a slider or mouse wheel by using finger gestures. Each solar array tile object can be autoscaled to show more or less information based on the current zoom level of the tile. For example, when the solar array tile object is larger it has more real estate, and so it can display more information and/or make the dials larger. As discussed, a user can double finger click anywhere on the array tile to drill down and navigate the user to the individual Power vs. DNI dashboard page for that solar array. Double finger clicking on the LED navigates the user to the Alerts page of that Array. The user may click left or right outside of array tiles to navigate to different dashboard pages at that level in the hierarchy. The navigation geographic shapes in the bottom portions, i.e. dark circles, give this visual indication of the other pages to the user.

In another embodiment, as shown in FIG. 6B, the user can finger scroll the list both up and down to bring a certain solar array-tile into view as well as laterally on the page 620B. The user can select one of the solar arrays by ‘clicking’ anywhere inside the tile. Solar array-tile objects can be automatically scaled to fit on the page without scrolling. As discussed, a user can double finger click anywhere on the dial array tile to drill down and navigate the user to the individual Power vs. DNI dashboard page for that solar array. However, the user may click on the upper menu to navigate to different dashboard pages at that level in the hierarchy.

Thus, in either embodiment, the energy-management-application presents on a displayed page, such as pages 620A and 620B, a visual indication of how the user should be able to navigate laterally across pages of a given level of hierarchy. The visual indication may be 1) merely geometric shapes, such as the black dots, indicating the number of pages laterally at that same level in the hierarchy, 2) a full menu indicating the pages at that same level in the hierarchy, or 3) something similar. The lateral pages contain different type of data and areas of data but all of the lateral pages for a given level of hierarchy in the menu are directly related to that level of hierarchy where the user has currently navigated to. For example see FIG. 3A, at a site level in the hierarchy the functionally related dashboard pages associated with that level of hierarchy including at least a first dashboard page to display one or more solar tracker tile objects parameters at that site; a second dashboard page to display Power vs. Energy produced at that site, a third dashboard page to display the total energy from all the inverters at that site; a forth dashboard page to display Weather or other site conditions at that site, a fifth dashboard page to display camera view of the site, and all of these dashboard pages are related to that specific hierarchy level.

Referring back to FIGS. 6A and 6b, the bottom main menu contains different page category icons. The different functions of the kinds of pages navigated to includes the following. A Dashboard page that provides summary information on the Power, DNI, Energy, Weather, Trackers, Inverters, etc. The dashboard pages may also provide the layout of the site using the Topography view. The Control page allows users to control the trackers for the solar arrays, upgrade software, and lock arrays (LOTO). The About page provides information about the array components. The Alerts page provides all alerts and ability to manage alerts. The Reports page provides summary reports of the performance, alerts, events, availability and array masters.

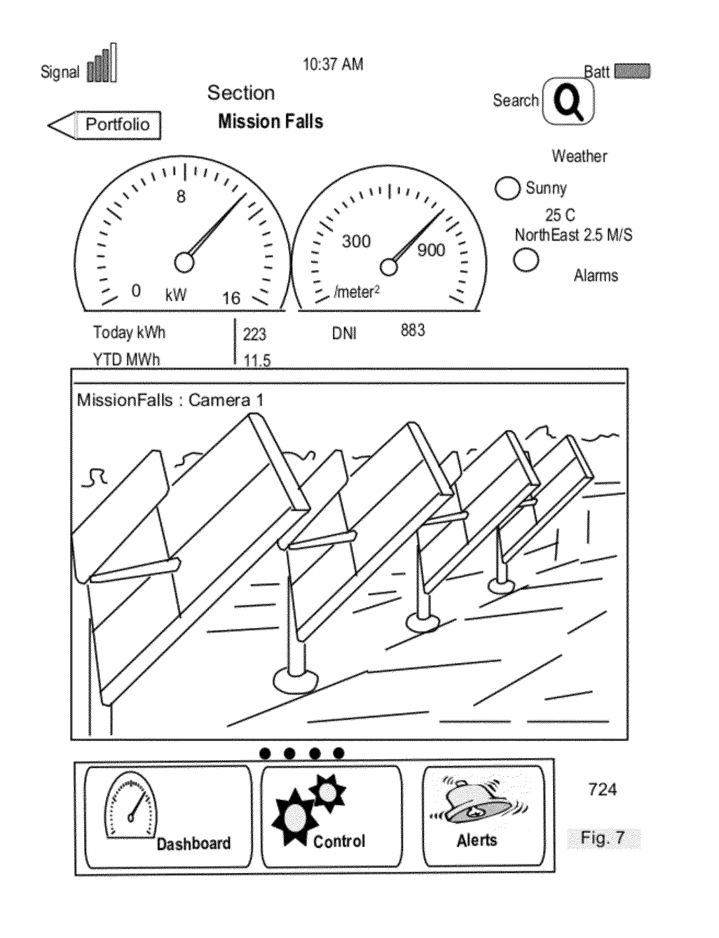

FIG. 7 illustrates an embodiment of example camera view dashboard page of a section of solar arrays at a section level in the hierarchical level presented by the graphic user interface of the energy-management-application onto the touch screen display of the mobile computing device. The energy-management-application presents a camera view dashboard page 724 that presents one or more still images captured by a camera located at the remote solar site.

The displayed still image is updated with a new still image of the site displayed at a regular periodic rate of seconds. The middle portion of the dashboard page 724 will visualize the currently selected view: the video camera view, where a jpg is retrieved from the server every, for example, 5 seconds, and refreshed on the screen. The video camera images are refreshed by a windows service and updated into the database at a regular point of time. The cameras also have the ability to update only during the daylight time to reduce the network traffic on the database. When the camera is configured to be daylight only, then the camera images are updated from 30 minutes before sunrise until 30 minutes after sunset. In a single camera window, a refresh control slider may be presented to control how fast the management server system checks to see if the Camera Image Service has deposited a new Image on the screen yet. The valid refresh rate range begins at every second and extends up to every 10 seconds. The settings section may also have the shake to rotate option enabled as well to update the displayed images.

The camera view dashboard page 724 of a section of solar arrays may also show two dials representing the Power & DNI of section and an alarms icon that changes colors when any alarm is present in the top portion of the page.

The camera view dashboard page 724 may also shows all camera views associated with the current browse level, or any of its children. If the same camera is associated with a section and an array, the application will only display that camera once. When a camera is clicked it will hide all other cameras, and show the selected camera at its maximum resolution. Clicking the camera image again returns to multiple camera view mode.

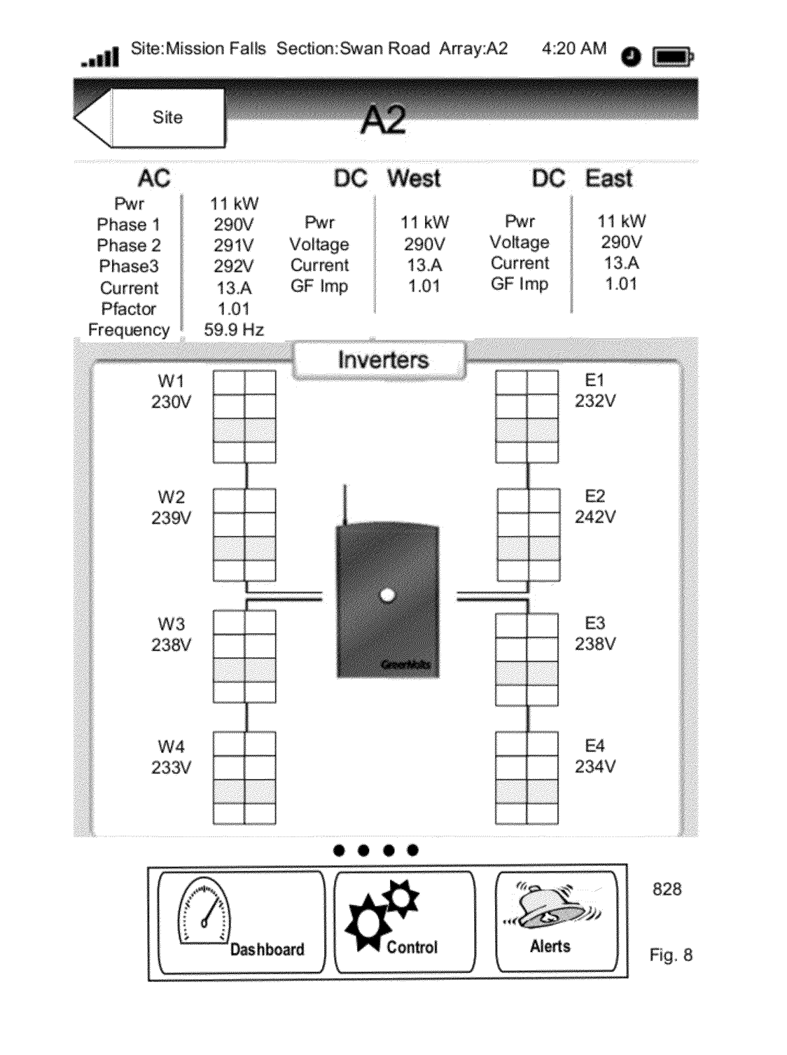

FIG. 8 illustrates an embodiment of example individual inverter dashboard page at an array/component level in the hierarchical level presented by the graphic user interface of the energy-management-application onto the touch screen display of the mobile computing device.

Each Concentrated Photovoltaic solar array is contained on a multiple-axis tracker mechanism. Each Concentrated Photovoltaic solar array may have both East and West strings of solar cells from the solar array feeding its own electrical power inverter. When navigated to in the Array level in the hierarchical level, the graphic user interface displays on the inverter dashboard page 828 both East and West Strings and electrical parameters (Power, DC_Voltage, DC_Current, GF_Voltage, GF_Current and GF_Impedence) of each ‘West’ and ‘East’ String. The graphic user interface also displays the power of each paddle on east & west side. The first letter in the paddle determines whether it refers to East (E) or West (W). The top portion has the level back icon to navigate up a level in the hierarchy and a title of the location the user has navigated to, solar array A2.

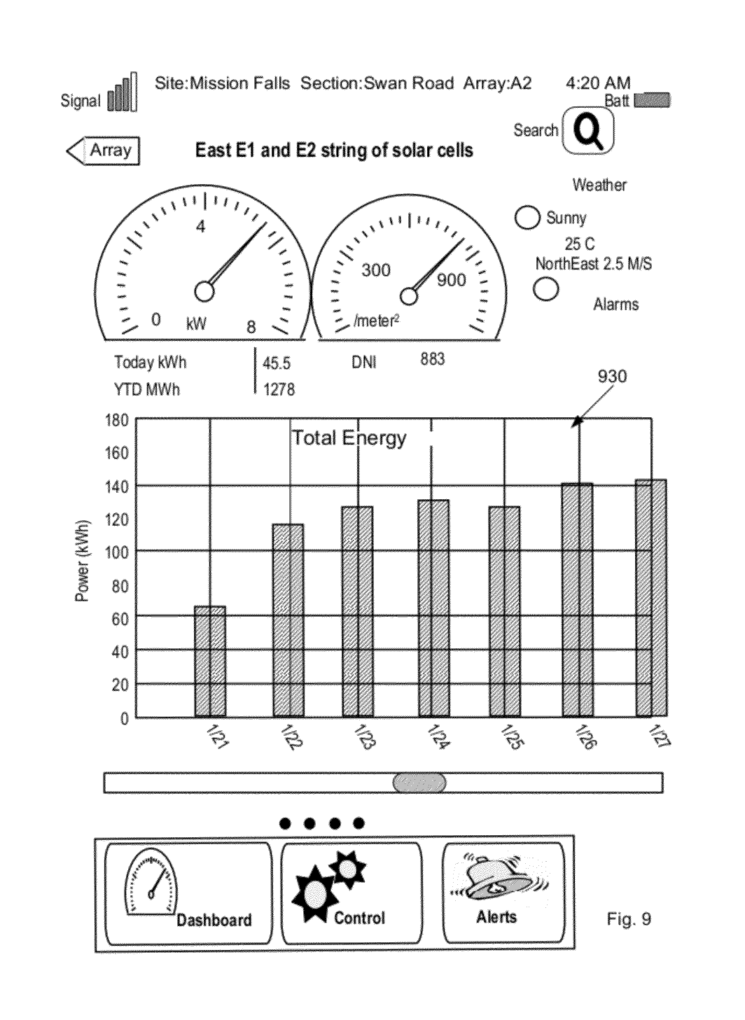

FIG. 9 illustrates an embodiment of example total energy dashboard page at a string of photovoltaic cells hierarchy level presented by a graphic user interface of an energy-management-application. The total energy graph shows the historical energy output of the currently selected hierarchy level. In this case, total energy graph 930 shows the historical energy output of the

East string of photovoltaic cells for solar array A2. Hovering over a bar on the bar graph displays the date/hour and the corresponding Power value for the time matching that particular bar. Swiping a user's finger left or right within the total energy graph 930 changes the date range of data displayed. The default scale for the total energy graph 930 is a 7-day range if no selection is made earlier. Clicking on a bar at the daily level drills down to the energy for that day with hourly granular level. The Y-Axis of the graph is auto-adjusted based on the energy values. The total energy graph 930 is located in the middle portion of the displayed page.

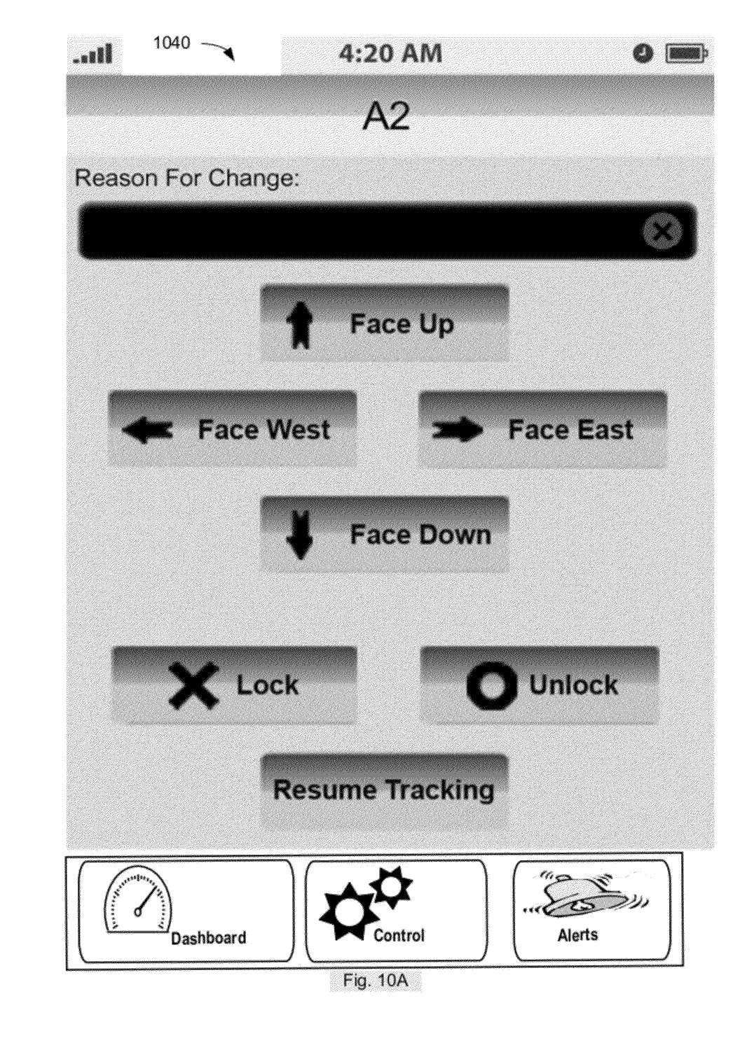

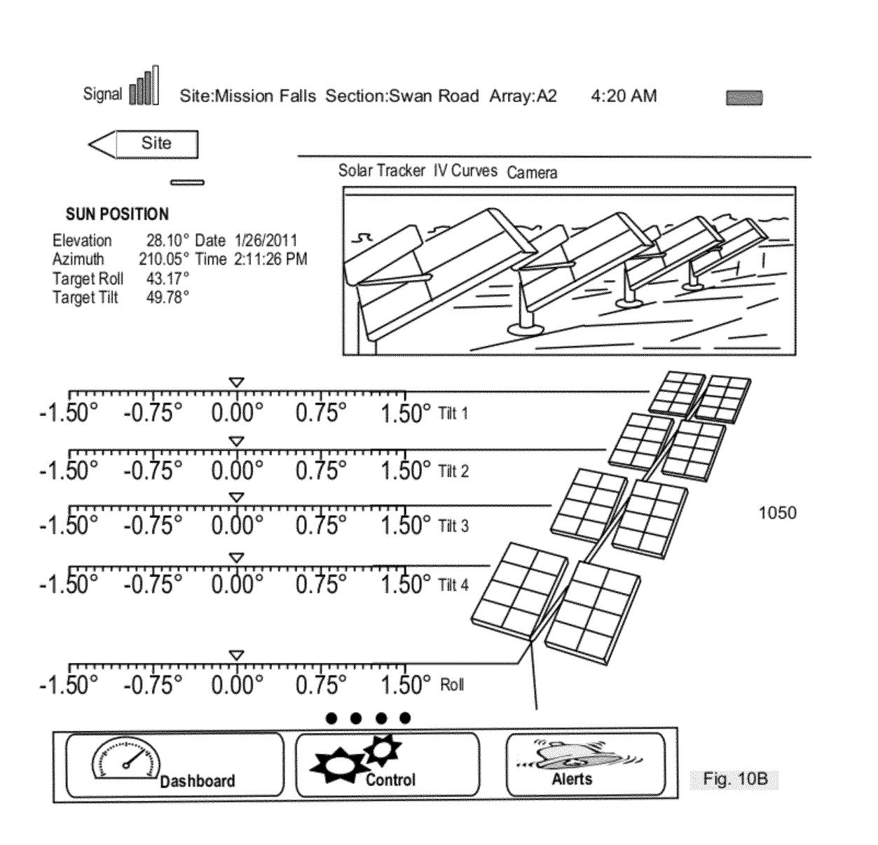

FIG. 10A illustrates an embodiment of example Control page at an array level in the hierarchical level presented by the graphic user interface of the energy-management-application onto the touch screen display of the mobile computing device.

The energy-management-application presents a main menu with a Control/Service icon that brings up a control page 1040. The control page 1040 will control the orientation and positioning of the solar arrays remotely from the mobile computing device. The Control page 1040 allows users to control the multiple axis trackers for each solar array, and potentially upgrade software, lock arrays into a stow position, and add maintenance logs.

The Control page icon on the menu bar may only become active/available to be activated when at a certain level in the hierarchy such as when an individual array dashboard page is presented.

The energy-management-application is configured to be used as a front end to collect and send the command information to the Internet-based backend management server system, and then the Internet-based backend management server system sends command instructions to given tracker to control the movement of that solar array. The Service Maintenance/Control page 1040 may also be grayed out disallowing an ability to control the tracker based on the user privileges at the currently selected entity. Only User IDs who have an access level of Site Admin and higher registered in the management server system can manage the solar arrays.

For each action that can be performed, a maintenance log entry is created. Some example, actions include moving the solar array to a specific position and/or placing the tracker into an automatic solar tracking mode.

The Move to Position command allows users to move the solar array to a specific position. Moving a solar array that is in tracking mode sets the array to Manual mode before moving the array to that position. There are several pre-defined movement commands (Face Up/Down/West/East), and a Custom Position. A Resume Tracking command places the tracker into an automatic solar tracking mode.

FIG. 10B illustrates an embodiment of example tracker dashboard page 1050 at an array level in the hierarchical level presented by the graphic user interface. For example, the user may move the position of the tracker from its 0.00 coordinates to plus or minus 1.50 degrees variant for each tilt axis as well as for the Roll axis.

Referring to FIG. 10A, maintenance commands may also be executed such as Solar Array Lock (LOTO—Lock Out Tag Out). A user ID with a Security Role >=3 (Admin, SysAdmin) can lock arrays. This allows users to perform a maintenance activity without letting others to manipulate with the solar array. Only the user who initiated a LOTO will be allowed to send commands to an array. Only the user who initiated the LOTO or a SysAdmin will be able to take an array out of locked state.

After any of the maintenance command buttons are pressed, and the application may present a standard confirmation ‘Are you Sure?’ popup box to appear, which allows the user to confirm the intended operation.

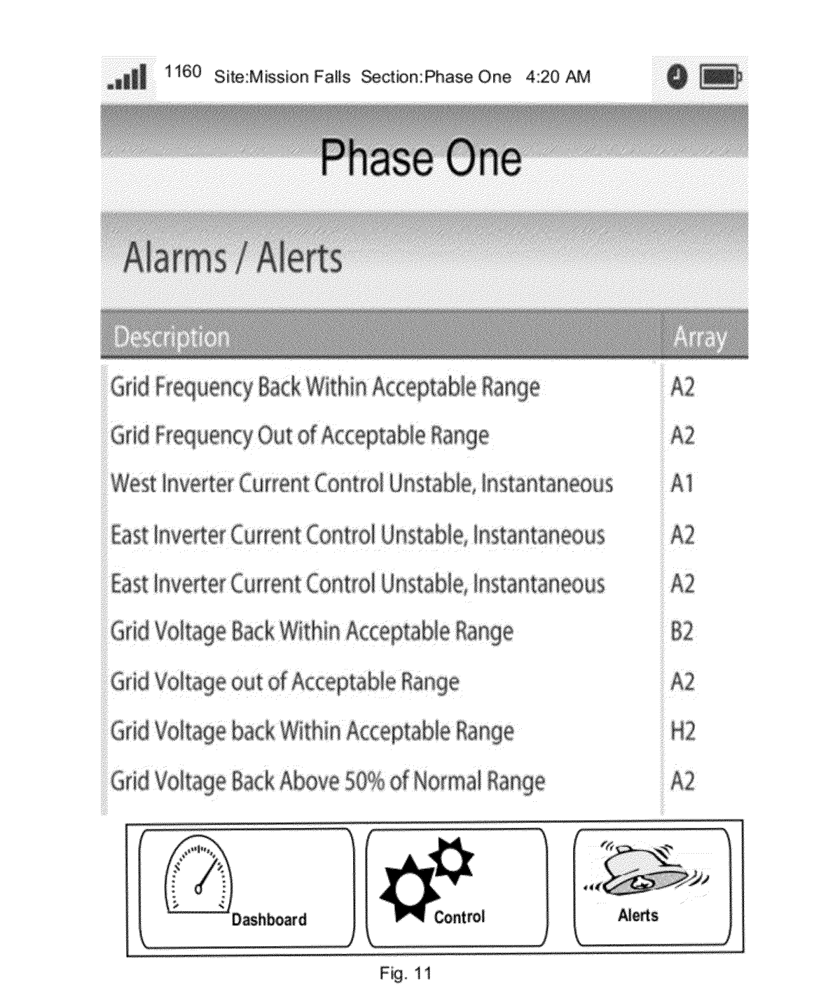

FIG. 11 illustrates an embodiment of example Alarms and Alerts page presented by a graphic user interface of an energy-management-application.

The Alerts/Alarms page 1160 displays all alarms that belong to the entities the current user has access to. Alarms are indicated as being Open Alerts or closed Alerts and indicate in some cases a severity level. The User can access more information about an Alarm in the list by finger clicking on the Alarm entry. The User can finger scroll up and down to see more alarms and alerts. A history of alarms can also be viewed.

Referring to FIG. 12, each of the solar sites 215, 220 may include hundreds or more photovoltaic arrays. Each of the photovoltaic arrays may be contained in a multiple-axis tracker mechanism that generates an AC voltage output. For some embodiments, a local System Control Point is located on each solar array and may include motion control circuits, inverters, ground fault circuits, etc. The SCP controls the movement of the tracker assemblies, receives DC power from the modules, converts the DC power to AC power, sends the AC power to a power grid, and collects and reports performance, position, diagnostic, and weather data to the backend management system 250. Tracker motion control circuitry and electrical power generating circuitry are locally contained on the multiple -axis tracker mechanism. Each of the photovoltaic arrays is configured with wireless communication circuitry to communicate information associated with the respective photovoltaic array to the management server system 250.

A user may use a client computing system 205 or 1210 to connect to the management server system 250 to manage the solar power generation site 215 and/or the solar power generation site 220. Each of the client computing systems 205, 1210 may be associated with a browser software to enable the users to use the Internet to access pages associated with the management server system 250. There may be a firewall 206 or 211 associated with each of the client computing systems 205 and 1210.

The management server system 250 may be configured to provide a large scale management system for monitoring and controlling many solar sites. From anywhere, a user with authorization and privileges can connect to the network 202 and monitor and control the solar arrays and the solar site where the solar arrays are located. Each solar site may also have one or more video cameras configured to provide information about what is happening at the solar site. The management server system 250 may use software as a service type model with secure networking to allow remote controlling and monitoring of the components at the solar site over the Internet. The software as a service can be software that is deployed over the Internet and is deployed to run behind a firewall on a private network. With the software as a service, application and data delivery is part of the utility computing model, where all of the technology is in the “cloud” accessed over the Internet as a service. The management server system 250 may be associated with a database, which may be configured to store information received from the various solar sites.

For some embodiments, a secured communication channel using Hypertext Transfer Protocol Secure (HTTPS) may be used for transmitting information between the SCP and the backend management system 250 over the network 202. The SCP may use HTTPS POST to send performance data to the server 250. The SCP may ping the backend management system 250 periodically (e.g., every one minute) even when the SCP 310 has no data to report.

As discussed, each solar array has multiple-axis tracker mechanism that includes a housing for the System Control Point. The management server system communicates with the System Control Point for each solar array at each solar generation site and also with each instance of the downloadable energy-management application on its own mobile computing device to present at least the data for the user interface to enable users to view information related to solar arrays in the one or more solar power generation sites in their portfolio.

Each of the Concentrated PhotoVoltaic solar arrays is coupled with a different system control point (SCP) that communicatively connects to the management server system associated with that solar site. Communications between a given SCP and the management server system are configured to use a secure communication channel protocol that verifies the identity of both the management server system and the SCP.

The backend management system 250 may be hosted on one or more servers. The browser-based access through the central backend management system 250 may be configured to allow near real-time system status and operational control of the arrays at the solar site.

Examples of well-known mobile computing systems suitable for use with the design include, but are not limited to, hand-held or laptop devices, tablets, PDA's, smart phones, and other similar devices.

The design may be described in the general context of computing device executable instructions, such as program modules, being executed by a computer. Generally, the program modules include routines, programs, objects, components, data structures, etc., that perform particular tasks or implement particular abstract data types. Those skilled in the art can implement the description and/or figures herein as computer-executable instructions, which can be embodied on any form of computing machine readable media discussed below.

The design may also be practiced in distributed computing environments where tasks are performed by remote processing devices that are linked through a communications network. In a distributed computing environment, program modules may be located in both local and remote computer storage media including memory storage devices.

Components of computing device may include, but are not limited to, a processing unit having one or more processing cores, a system memory, and a system bus that couples various system components including the system memory to the processing unit.

Computing device typically includes a variety of non-transitory computing machine-readable media. Computing machine-readable media can be any available media that can be accessed by computing device and includes both volatile and nonvolatile media, removable and non-removable media. By way of example, and not limitation, computing machine-readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device. Portions of the energy-management-application may be implemented in software, electronic circuit and any combination of the two and software may be stored on a non-transitory computing-device readable-medium in an executable format by a processor.

System memory includes computer storage media in the form of volatile and/or nonvolatile memory such as read only memory (ROM) and random access memory (RAM). A basic input/output system (BIOS), containing the basic routines that help to transfer information between elements within computing device, such as during start-up, is typically stored in ROM. RAM typically contains data and/or program modules that are immediately accessible to and/or presently being operated on by processing unit. By way of example, and not limitation, computing device includes operating system, application programs, other program modules, and program data. A browser application may be resident on the computing device and stored in the memory.

When used in a LAN networking environment, the computing device is connected to the LAN through a network interface or adapter. When used in a WAN networking environment, the computing device typically includes a communication module or other means for establishing communications over the WAN, such as the Internet. The communication module may be a modem used for wired, wireless communication or both.

Another component in the mobile computing device that may be coupled to bus is a power supply such as a battery and alternating current (AC) adapter circuit. As discussed above, the DC power supply may be a battery, a fuel cell, or similar DC power source that needs to be recharged on a periodic basis. For wireless communication, the communication module may employ a Wireless Application Protocol to establish a wireless communication channel. The communication module may implement a wireless networking standard such as Institute of Electrical and Electronics Engineers (IEEE) 802.11 standard, IEEE std. 802.11-1999, published by IEEE in 1999.

Although the foregoing embodiments have been described in some detail for purposes of clarity of understanding, the invention is not limited to the details provided. Functionality of circuit blocks may be implemented in hardware logic, active components including capacitors and inductors, resistors, and other similar electrical components. Software instructions may be implemented in Boolean logic hardware. A processor may execute software. There are many alternative ways of implementing the invention. The disclosed embodiments are illustrative and not restrictive.

We claim:

1. An apparatus, comprising:
an energy-management-application configured to operate on a mobile computing device, where the energy management application is configured to connect to and facilitate bidirectional communications with an Internet-based management server system, where the energy-management-application is also configured to present a touch-screen graphic user interface with multiple pages to both 1) monitor information, including site conditions and electrical energy production, regarding one or more remote solar-powered generation sites and 2) control components, including positioning of solar arrays, within the one or more remote solar-powered generation sites from the mobile computing device having a touch screen display, where the graphic user interface is configured to display on the touch screen a sequence of the multiple pages, where each page contains any of a list of data items, links, and objects, across various hierarchical levels of the one or more remote solar-powered generation sites on the touch screen display, where the sequence of the multiple pages are organized into the hierarchical levels going from an overview of the one or more remote solar-powered generation sites to lower levels including individual components making up an individual remote solar-powered generation site; and
where the energy-management-application is configured to detect as an input on a currently displayed page from the sequence of multiple pages both a rate and a pattern of finger swipe gestures made on the currently displayed page displayed on the touch screen display; and in response to detection of both the rate and pattern of the finger gestures on the touch screen, the energy-management-application performs at least one of 1) activate one or more of the data items, one or more of the links, or one or more of the objects, and 2) navigate to another page in the sequence of pages, where a user of the mobile computing device is able to interact with the energy-management-application to control and monitor the one or more solar power generation sites by navigating through the sequence of multiple pages, interacting with the data items, the links, and the objects contained on the pages, where any portions of the energy-management-application implemented in software are stored on a non-transitory computing-device readable-medium in an executable format.

2. The apparatus of claim 1, where the graphic user interface of the energy-management-application is configured to guide a web browser of the mobile computing device through the sequence of pages, organized as the hierarchical levels of the one or more solar power generation sites, that can be drilled-down in, drilled-up in, and navigated laterally within while in a given hierarchical level, where each different level of granularity of a solar power system and the hierarchy follows the ordering from the high level overview of the one or more solar power generation sites, to a lower level of individual solar power generation sites, to an even lower level of individual components making up a particular individual solar power generation site, and where two or more solar arrays make up an individual solar power generation site.

3. The apparatus of claim 1, wherein the graphic user interface of the energy-management-application is configured to detect two or more of the following 1) a finger touch on a specific geographic location on the displayed page on the touch screen display, 2) the finger touch rate on the touch screen display at that geographic location on the displayed page within set amount of time, 3) an activation of the icon at that geographic location on the displayed page by the finger touch, and 4) the finger touch pattern on the touch screen display, and where the finger touch pattern includes any of a pinching gesture with two fingers while contacting the touch screen to magnify that portion of the displayed page on the display screen, a horizontal finger swipe across the touch screen to move the displayed page in the direction of the finger swipe or navigate laterally to another page within that level of the hierarchy, a multiple finger tap at approximately the same coordinates on the touch screen to drill down a level in the hierarchy, or activate an object, link, or data item, and a vertical finger swipe to cause scrolling normally along an edge of the display screen.

4. The apparatus of claim 1, wherein the graphic user interface of the energy-management-application is configured to present the sequence of pages starting from a log-in page onto then one or more dashboard pages that display at least the site conditions and electrical energy production, and onto then other types of pages, where the graphic user interface of the energy-management-application also presents and allows navigation to at least Alert pages to display any alert and alarm conditions in the one or more solar power generation sites, and Control pages to control solar array positions in the one or more solar power generation sites.

5. The apparatus of claim 1, wherein the graphic user interface essentially divides the touch screen display into two or more portions for the displayed page from the sequence of pages, wherein the graphic user interface of the energy-management-application is configured to allow a user to navigate between dashboard pages, alarm list pages, and control pages, by selecting a corresponding page icon on a menu bar in the bottom portion of the displayed page.

6. The apparatus of claim 1, wherein the energy-management-application contains at least two levels of menus, a main menu toolbar that contains page category icons, which the user can navigate by clicking on the page category icons, and the page category icons at least include a control icon to navigate to a control page configured to allow a user to move the one or more solar arrays in a solar power generation site; an alerts icon to navigate to a control page configured to allow a user to view and respond to alarm conditions; and a dashboard icon to navigate to a plurality of dashboard pages at that level in the hierarchy configured to allow a user to view a snapshot of information regarding the solar arrays contained at that level in the hierarchy, where a detailed sub menu structure is presented by the graphic user interface for each main menu page category.

7. The apparatus of claim 1, wherein the energy-management-application is configured to present a main menu with a control page icon that brings up a control page, where the control page has objects to control an orientation and positioning of the solar arrays remotely from the mobile computing device, and where the energy-management-application is also configured to be used as a front end to collect and send command information to the Internet-based management server system and the Internet-based management server system then sends command instructions to a given solar array to control the orientation and positioning of that solar array.

8. The apparatus of claim 1, wherein the energy-management-application is configured to initially navigate a user to a portfolio dashboard page in the sequence of pages, where the portfolio dashboard page displays an overview of the one or more solar power generation sites, where the portfolio dashboard page in the hierarchal level presents a tile object for each of the solar generation sites that the user is allowed to see, where the energy-management-application is also configured to detect a finger scrolling gesture to go up and down on a list of the tile objects in order to bring a certain solar generation site-tile object into view on the portfolio dashboard page.

9. The apparatus of claim 8, wherein each solar generation site-tile object may include two or more dials indicating 1) current electrical power generation being produced at that solar-powered generation site and 2) an amount of Sun present at that solar-powered generation site, which the displayed combination allows an easy detection of a properly functioning solar-powered generation site from a solar-powered generation site that may have a problem, where the energy-management-application allows the user to select individual solar-powered generation sites to navigate to by finger ‘clicking’ with two or more finger pressess in a rapid succession in a set period of time on that individual solar generation site-tile object on the portfolio page.

10. The apparatus of claim 1, wherein the energy-management-application is configured to have a settings plug-in routine that is scripted to work with and integrate with a settings' routine of the mobile computing device, where the settings' plug-in routine acts as an interface so that the settings page of the mobile application is accessible from at least one of 1) a standard ‘settings’ folder of the mobile computing device, and 2) a settings link from the sequence of pages presented by the mobile downloadable application, where a field and an algorithm of the settings page are configured to sign in the user of this mobile device into the Internet-based management server system automatically when the energy-management application is resident and run on the mobile computing device and when automatically signed-in an initial log-in page will skipped in the sequence of presented pages.

11. The apparatus of claim 1, wherein the energy-management-application is configured to present on a top portion of a displayed page a title of the location a browser of the mobile computing device has currently navigated to in the hierarchical levels and a visual indication of how to navigate through the hierarchy of levels.

12. The apparatus of claim 11, wherein the visual indication is a pop up window with a table of user selectable options of the levels of hierarchy and pages the user is allowed to navigate to and the user may select the specific level in the hierarchy presented in the table that the user wishes to navigate to.

13. The apparatus of claim 11, wherein the visual indication is a Back button that allows the navigation up the hierarchical levels by detecting a finger of the user depressing the Back button in the top portion of the displayed page that navigates to a next higher level in the hierarchical levels, and where a user performs a multiple finger tap at approximately a same coordinates on a tile object on the touch screen to navigate down the hierarchical levels.

14. The apparatus of claim 1, wherein the energy-management-application is configured to present on a displayed page from the sequence of pages a visual indication when a user should be able to navigate laterally across pages within a given level of hierarchy, where the visual indication is at least one of 1) two or more geometric shapes indicating the number of pages laterally at that same level in the hierarchy and 2) a toolbar with page icons indicating the pages at that same level in the hierarchy, where the lateral pages contain different type of data and areas of data but all of the lateral pages for a given level of hierarchy in the menu are directly related to that level of hierarchy.

15. The apparatus of claim 1, wherein the energy-management-application is configured to provide and display a first page from the sequence of pages and the first page contains one or more tile objects that each incorporate a graphics design file, where each of these tile objects are constructed with at least a two-tier image system that includes 1) a composite of one or more fixed images and then 2) a data overlay display onto the fixed images, where the data overlay display updates and illustrates data content periodically sent from the management server system.

16. The apparatus of claim 1, wherein the energy-management-application is configured to present a displayed page that presents one or more still images captured by a camera located at a first remote solar-powered generation site, where a displayed still image is updated with a new still image of the site displayed at a regular periodic rate.

17. A method to manage one or more remote solar-powered generation sites from an energy-management application resident on a mobile computing device, comprising:
facilitating bidirectional communications between an Internet-based management server system and the energy-management-application;
presenting a touch-screen graphic user interface with multiple pages to both 1) monitor information, including site conditions and electrical energy production, regarding one or more remote solar-powered generation sites and 2) control components, including positioning of solar arrays, within the one or more remote solar-powered generation sites from the mobile computing device having a touch screen display, where the graphic user interface is configured to display on the touch screen a sequence of the multiple pages, where each page contains any of a list of data items, links, and objects, across various hierarchical levels of the one or more remote solar-powered generation sites on the touch screen display, where the sequence of the multiple pages are organized into the hierarchical levels going from an overview of the one or more remote solar-powered generation sites to lower levels including individual components making up an individual remote solar-powered generation site; and
detecting as an input on a currently displayed page from the sequence of multiple pages both a rate and a pattern of finger swipe gestures made on the currently displayed page displayed on the touch screen display;
and in response to detection of both the rate and pattern of the finger gestures on the touch screen, performing at least one of 1) activation of one or more of the data items, one or more of the links, or one or more of the objects, and 2) navigation to another page in the sequence of pages, where a user of the mobile computing device is able to interact with the energy-management-application to control and monitor the one or more solar power generation sites by navigating through the sequence of multiple pages, interacting with the data items, the links, and the objects contained on the pages.

18. The method of claim 17, comprising:
guiding a web browser of the mobile computing device through the sequence of pages, organized as the hierarchical levels of the one or more solar power generation sites, that can be drilled-down in, drilled-up in, and navigated laterally within while in a given hierarchical level, where each different level of granularity of a solar power system and the hierarchy follows the ordering from the high level overview of the one or more solar power generation sites, to a lower level of individual solar power generation sites, to an even lower level of individual components making up a particular individual solar power generation site, and where two or more solar arrays make up an individual solar power generation site.

19. The method of claim 18, wherein the graphic user interface of the energy-management-application is configured to present the sequence of pages starting from a log-in page onto then one or more dashboard pages that display at least the site conditions and electrical energy production, and onto then other types of pages, where the graphic user interface of the energy-management-application also presents and allows navigation to at least Alert pages to display any alert and alarm conditions in the one or more solar power generation sites, and Control pages to control solar array positions in the one or more solar power generation sites.

20. The method of claim 18, wherein the energy-management-application is configured to initially navigate a user to a portfolio dashboard page in the one or more dashboard pages, where the portfolio dashboard page displays an overview of the one or more solar power generation sites, where the portfolio dashboard page in the hierarchal level presents a tile object for each of the solar power generation sites that the user is allowed to see, where each solar generation site-tile object includes two or more dials indicating 1) current electrical power generation being produced at that solar-powered generation site and 2) an amount of Sun present at that solar-powered generation site, which the displayed combination allows an easy detection of a properly functioning solar-powered generation site from a solar-powered generation site that may have a problem.
